(19) United States
(12) Patent Application Publication
(10) Pub. No.: US 2006/0030514 A1
(43) Pub. Date: Feb. 9, 2006

(54) Fabric conditioning compositions

(75) Inventors: Stuart Bernard Fraser, Little Neston (GB); Neil Fletcher Taylor, Bebington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER

(21) Appl. No.: 11/197,701

(22) Filed: Aug. 4, 2005

(30) Foreign Application Priority Data
Aug. 5, 2004 (GB) 0418071.7

(51) Int. Cl. C11D 3/00

(52) U.S. Cl. 510/515

(57) ABSTRACT

A stable, pourable clear or translucent fabric conditioning composition comprising one or more cationic fabric softening materials having an iodine value of from 5 to 140, one or more oils and/or low molecular weight solvents, and one or more hydrophobic fluorescers.

### FIELD OF THE INVENTION

The present invention relates to fabric conditioning compositions, and in particular, relates to liquid fabric softener compositions comprising a fluorescer.

### BACKGROUND OF THE INVENTION

Rinse added fabric conditioning compositions are well known. Typically, such compositions comprise a liquid or solid fabric softening agent dispersed in an aqueous medium. The fabric softening agent can be included at up to 8% by weight, in which case the compositions are considered dilute, or at levels from 8% to 60% by weight, in which case the compositions are considered concentrated.

One of the problems frequently associated with conventional fabric conditioner compositions is that, upon repeated use, yellowing can occur.

It has been suggested in the prior art to address this problem by incorporating a fluorescent dye, such as the salt of a diaminostilbene (DAS) derivative, within the fabric conditioning composition. However, as this is an anionic compound, it can adversely affect the performance of the softening compound when such a compound is cationic. Also, any complex with a cationic softening compound may give reduced stability against photodegradation. Thus, it may decompose and lose any fluorescing benefits.

EP 275694, U.S. Pat. No. 4,497,718 and U.S. Pat. No. 4,562,002 all disclose rinse conditioner compositions containing a fluorescent dye based on a diaminostilbene derivative.

EP 368383 discloses a tumble dryer sheet with sodium salt of a fluorescent agent.

U.S. Pat. No. 6,164,100 describes a rinse conditioning product containing a polymer with fluorescent units attached thereto.

JP 10219297 discloses a rinse aid consisting of a polybasic acid and a fluorescer. The compositions disclosed appear to lack softening compounds.

U.S. Pat. No. 5,935,272 discloses a water soluble fluorescent dye-stuff.

U.S. Pat. No. 4,460,374 discloses a process for whitening a textile, particularly made-up goods such as curtains and underwear, comprising the step of applying to the textile in an aqueous medium a composition which comprises
a) an organic solvent which is sparingly soluble to insoluble in water and in which component (b) is dissolved and component (c) is dissolved or dispersed.
b) a vehicle for component (c) which is sparingly soluble to insoluble in water, and
c) a fluorescent whitening agent which is sparingly soluble to insoluble in water and which is soluble or dispersible in the vehicle (b).

Increasingly, clear fabric conditioning compositions are desired by the consumer. Therefore, it is desirable to provide a clear composition which has a greatly enhanced appearance.

WO 98/52907 describes a cationic fabric conditioning composition which may optionally be clear and may contain a diaminostilbene derivative fluorescer. The diaminostilbene fluorescer is classified as hydrophilic.

However, this does not address the problem of providing a clear or translucent liquid fabric conditioning composition comprising a cationic softening compound and a fluorescer which is stable to photodegradation.

### OBJECTS OF THE INVENTION

Thus, the present invention seeks to address one or more of the above-mentioned problems, and, to give one or more of the above-mentioned benefits desired by consumers.

Surprisingly, we have found that a clear or translucent fabric conditioning composition comprising a fluorescer of the type defined in claim 1 is stable against photodegradation.

Furthermore, we have found that such a composition provides a greatly enhanced appearance to the clear or translucent composition. Also, it provides increased stability against photodegradation for other products (when present) in the composition, e.g. dyes and perfumes.

### SUMMARY OF THE INVENTION

According to the present invention there is provided an clear or translucent liquid fabric conditioning composition comprising:
(i) one or more cationic fabric softening materials having an iodine value of from 5 to 140;
(ii) one or more oils and/or low molecular weight solvents; and
(iii) one or more hydrophobic fluorescers,
   wherein the weight ratio of cationic softening material to oil, when present is in the range 5:1 to 10:1 and the weight ratio of cationic softening material is low molecular weight solvent when present is in the range 8:1 to 1:3.

Preferably the fluorescer is solubilised in the organic phase of the composition.

According to a further aspect of the invention, there is provided a method of conditioning fabrics comprising contacting the above-mentioned fabric conditioning composition with fabrics.

According to another aspect of the invention, there is provided the use of a fluorescer in a fabric conditioning composition to reduce yellowing of fabrics wherein the fluorescer is solubilised in the organic phase of the composition.

In the context of the present invention, the term “comprising” means “including”. That is the steps, components, ingredients, or features to which the term “comprising” refers are not exhaustive.

### DETAILED DESCRIPTION OF THE INVENTION

The present invention is particularly concerned with clear or translucent liquid fabric softening compositions.

Such a product is preferably, though not essentially, a microemulsion. That is a product which is isotropic and thermodynamically stable over a specified temperature range.

Fluorescer

The clear or translucent composition of the present invention comprises a fluorescer which is hydrophobic.

By hydrophobic it is meant that the fluorescer has a hydrophobicity, measured by C log P, of 3 to 50, more preferably 4 to 50, most preferably 5 to 50, e.g. 6 to 50.

C log P is measured using the “C log P” program (calculation of hydrophobicities as log P (oil/water)) version 4.01, available from Daylight Chemical Information Systems Inc of Irvine Calif., USA. A commercially available fluorescer of this type is Blankophor DCB (4-[3-(4-chlorophenyl)-4,5-dihydro-1h-pyrazol-1-yl]benzenesulphonamide), ex Bayer.

Preferably the fluorescer is solubilised in the organic phase of the composition. It has been observed that this provides a greater deposition of the fluorescer onto synthetic materials, e.g. polyesters, than if the fluorescer is solubilised in the aqueous phase of the composition.

Typically, the fluorescer is present at a level of from 0.001 to 2 wt %, more preferably from 0.003 to 1.5 wt %, most preferably from 0.004 to 1 wt %, e.g. 0.005 to 0.8 wt %, based on the total weight of the composition.

Excluded Fluorescers

Hydrophilic fluorescers, as described below, are not suitable for use in the compositions of the present invention.

Diaminostilbene disulphonic acid type fluorescers (hereinafter referred to as “DAS”) are classified as hydrophilic in WO-A-98/52907. A commercial example of a DAS is Tinopal DMS (ex CIBA).

Another type of hydrophilic fluorescer is a distyrylbiphenyl fluorescer (hereinafter referred to as “DSBP”). A commercial example of this type of fluorescer is Tinopal CBS-X (also ex CIBA).

These materials were introduced, as purchased, at a level of 0.1 wt %, into a standard concentrate fabric softening composition (Comfort Concentrate, purchased UK 2004) and a clear fabric softening composition (Lenor Enhancer, purchased UK 2004) by post-dosing and stirring. In both cases, the fluorescer formed large clumps of yellow solid particles. Thus, they do not form stable compositions, as is required by the compositions of the present invention.

Without wishing to be bound by theory, it is believed that both DAS and DSPB fluorescers complex with cationic materials, e.g. cationic softening agents, that are typically present in softening compositions forming insoluble flocs.

Cationic Fabric Softening Material

The fabric conditioning composition of the present invention comprises one or more cationic softening materials typically included in rinse-added fabric softening compositions.

The surfactants may comprise quaternary ammonium compounds.

It is especially preferred if the cationic surfactant is a water insoluble quaternary ammonium material which comprises a compound having two C₁₂₋₁₈ alkyl or alkenyl groups connected to the nitrogen head group via at least one ester link. It is more preferred if the quaternary ammonium material has two ester links present.

A first group of preferred ester-linked cationic surfactant materials for use in the invention is represented by formula (I): 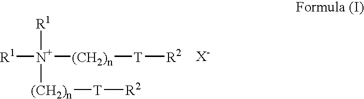
wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups;
T is

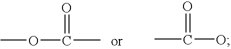

X⁻ is any anion compatible with the cationic surfactant, such as halides or alkyl sulphates, e.g. chloride, methyl sulphate or ethyl sulphate and n is 0 or an integer from 1-5.

Especially preferred materials within this formula are di-alkenyl esters of triethanol ammonium methyl sulphate and N-N-di(tallowoyloxy ethyl)N,N-dimethyl ammonium chloride.

Commercial examples of compounds within this formula are Tetranyl AOT-1 (di-oleic ester of triethanol ammonium methyl sulphate 80% active), AO-1(di-oleic ester of triethanol ammonium methyl sulphate 90% active), L1/90 (partially hardened tallow ester of triethanol ammonium methyl sulphate 90% active), L5/90 (palm ester of triethanol ammonium methyl sulphate 90% active (supplied by Kao corporation) and Rewoquat WE15 (C₁₀-C₂₀ and C₁₆-C₁₈ unsaturated fatty acid reaction products with triethanolamine dimethyl sulphate quaternised 90% active), ex Witco Corporation.

A second preferred type of quaternary ammonium material is represented by formula (II): 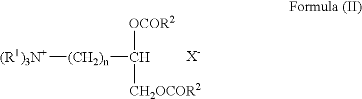
wherein R¹, R², n and X⁻ are as defined above.

Preferred materials of this class such as 1,2 bis[tallowoyloxy]-3- trimethylammonium propane chloride and 1,2-bis[oleyloxy]-3-trimethylammonium propane chloride and their method of preparation are, for example, described in U.S. Pat. No. 4,137,180 (Lever Brothers), the contents of which are incorporated herein. Preferably these materials also comprise small amounts of the corresponding monoester, as described in U.S. Pat. No. 4,137,180.

A third preferred type of quaternary ammonium material is represented by formula (III): 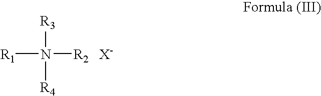
where R₁ and R₂ are C₈₋₂₈ alkyl or alkenyl groups; R₃ and R₄ are C₁₋₄ alkyl or C₂₋₄ alkenyl groups and X⁻ is as defined above.

Examples of compounds within this formula include di(tallow alkyl)dimethyl ammonium chloride, di(tallow alkyl)dimethyl ammonium methyl sulphate, dihexadecyl dimethyl ammonium chloride, dioctadecyl dimethyl ammonium chloride and di(coconut alkyl)dimethyl ammonium chloride.

It is advantageous for environmental reasons if the quaternary ammonium material is biologically degradable.

Preferably, the cationic surfactants are present in the composition in amount from 2-80% by weight of cationic surfactant (active ingredient) based on the total weight of the composition, more preferably 2.5-65% by weight, most preferably 3-51% by weight.

If it is desired to provide the composition as a concentrate, then the cationic surfactants are preferably present in an amount of 10-80% by weight of cationic surfactant (active ingredient) based on the total weight of the composition, more preferably 11-45% by weight, most preferably 12-40% by weight.

Preferred cationic surfactant compounds are substantially water insoluble.

The iodine value of the quaternary ammonium softening agent is from 5 to 140, preferably 10 to 120, more preferably 15 to 100, most preferably 25 to 97, e.g. 35 to 95.

The cis:trans isomer weight ratio of the chains in the fatty acid/fatty acyl compound is greater than 20:80, preferably greater than 30:70, more preferably greater than 40:60, most preferably greater than 50:50, e.g. 70:30 or greater. It is believed that higher cis:trans isomer weight ratios afford the compositions comprising the compound better low temperature stability and minimal odour formation. Suitable fatty acids include Radiacid 406, ex. Fina.

Of course, the cis:trans isomer weight ratios can be controlled during hydrogenation by methods known in the art such as by optimal mixing, using specific catalysts and providing high H₂ availability.

Saturated and unsaturated fatty acids/acyl compounds may be mixed together in varying amounts to provide a compound having the desired iodine value.

Iodine Value of the Parent Fatty Acid

The method for calculating the iodine value is as described on page 12 lines 6 to 28 of WO-A1-01/04254, the contents of which are incorporated herein.

Oils

The compositions of the present invention comprise at least one oil and/or one low molecular weight solvent. The oil may be a mineral oil, an ester oil and/or natural oils such as vegetable oils. However, ester oils or mineral oils are preferred.

The ester oils are preferably hydrophobic in nature. They include fatty esters of mono or polyhydric alcohols having from 1 to 24 carbon atoms in the hydrocarbon chain, and mono or polycarboxylic acids having from 1 to 24 carbon atoms in the hydrocarbon chain, provided that the total number of carbon atoms in the ester oil is equal to or greater than 16, and that at least one of the hydrocarbon chains has 12 or more carbon atoms.

Suitable ester oils include saturated ester oils, such as the PRIOLUBES and ESTOLS (ex. Uniqema). 2-ethyl hexyl stearate (PRIOLUBE 1545), neopentyl glycol monomerate (PRIOLUBE 2045), methyl laurate (PRIOLUBE 1415), isopropyl myristate (ESTOL 1514), propylene glycol dicaprylate (ESTOL 1526) and ethyl hexyl cocoate (ESTOL 1540) are particularly preferred although oleic monoglyceride (PRIOLUBE 1407) and neopentyl glycol dioleate (PRIOLUBE 1446) are also suitable.

The ester oil may also be a CPE or RSE polyester oil, as defined on page 4 line 28 to page 9 line 16 of WO-A1-98/16538, the content of which is incorporated herein.

It is preferred that the viscosity of the ester oil is from 0.002 to 0.4 Pa.S (2 to 400 cps) at a temperature of 25° C. at 106 s⁻¹, measured using a Haake rotoviscometer, and that the density of the mineral oil is from 0.8 to 0.9 g.cm⁻³ at 25° C.

Suitable mineral oils include branched or straight chain hydrocarbons (e.g. paraffins) having 8 to 35, more preferably 9 to 20 carbon atoms in the hydrocarbon chain.

Preferred mineral oils include the Marcol technical range of oils (ex Esso) although particularly preferred is the Sirius range (ex Silkolene) or Semtol (ex. Witco Corp.). The molecular weight of the mineral oil is typically within the range 100 to 400.

One or more oils of any of the above mentioned types may be used.

It is believed that the oil provides excellent perfume delivery to the cloth and also increases perfume longevity upon storage of the composition.

The oil may be present in an amount from 11-70% by weight, more preferably 12-60%, by weight most preferably 15-52%, e.g. 20-45% by weight, based on the total weight of the composition.

The weight ratio of cationic softener to oil in the composition is in the range from 5:1 to 1:10, preferably from 4:1 to 1:5, more preferably from 3:1 to 1:3.

The oil referred to herein, is preferably added to the composition as a separate component, that is, in addition to any oil which may be present in other components of the composition.

Low Molecular Weight Solvent

The solvent is preferably organic, such as a low molecular weight (preferably 180 or less) alcohol, including monohydric and polyhydric alcohols, e.g. diols.

The presence of the lower molecular weight alcohol helps improve physical stability upon storage by lowering the viscosity to a more desired level and also assists the formation of the micro-emulsion. Examples of suitable alcohols include ethanol, isopropanol, n-propanol, dipropylene glycol, t-butyl alcohol, 2,2,4-trimethyl-1,3-pentanediol (TMP), hexylene glycol, and glycerol.

Although the foregoing are suitable, it is especially desirable to use a combination of 2,2,4-trimethyl-1,3-pentanediol (TMP) and hexylene glycol. This combination is far superior to other alcohols in solubilising the components of the composition whilst avoiding undesirable odours.

The solvent may be added to the composition either by being present as a component in the cationic surfactant or it may be added separately.

The solvent is preferably present in an amount from 0.05% to 40% by weight, more preferably from 0.1% to 25% by weight, most preferably from 0.15% to 16% by weight, based on the total weight of the composition.

The weight ratio of cationic softener to solvent in the composition is in the range from 8:1 to 1:3, preferably from 6:1 to 1:2, more preferably from 4:1 to 1:1.

Mixtures of solvents may be used if desired.

Water

The compositions of the invention may be aqueous based.

Typically, the level of water present is from 0.5-99% by weight, more preferably 1-89% by weight, even more preferably 2-87% by weight, most preferably 3-85% by weight, based on the total weight of the composition.

Dispersion Aids

Optionally and advantageously, the compositions contain one or more dispersion aids. The dispersion aid assists the dispersion of the micro-emulsion when it is diluted in water.

Especially preferred dispersion aids for use in the compositions of the invention are alkoxylated nonionic fatty alcohols, such as C₁₀-C₂₂ alkyl/alkenyl alkoxylated with 3-20 moles alkoxy moieties. The fatty alcohols may be alkoxylated with ethylene oxide, propylene oxide or ethylene oxide/propylene oxide mixtures.

Other dispersion aids which may be used in the compositions of the invention can be selected from mono-long chain alkyl cationic quaternary ammonium compounds and mono-long chain alkyl amine oxides.

Preferably the concentration of the dispersion aid is from 0.05-30% by weight, more preferably from 0.3-20% by weight, most preferably from 1-15% by weight, based on the total weight of the composition.

The dispersion aid may also act as a stabiliser for the micro-emulsion so that addition of the dispersion aid provides a more stable micro-emulsion product.

The weight ratio of the quaternary cationic softening compound to the total amount of dispersion aid is from 3:1 to 8:1, more preferably 5:1 to 7:1.

Anti-Oxidation/Reduction Stabilisers

The compositions of the invention may, optionally, comprise one or more additional stabilisers which stabilise against oxidation and/or reduction.

If the stabilisers are present as anti-oxidants, they may be added at a level of from 0.005 to 2% by weight based on the total weight of the composition, more preferably from 0.01 to 0.2% by weight, most preferably from 0.035% to 0.1% by weight.

If present as an anti-reduction agent, then the stabiliser is preferably used in an amount from 0.001% to 0.2% by weight based on the total weight of the composition.

The stabilisers assist by assuring good odour stability upon storage particularly when the composition is prepared using a surfactant having substantial unsaturated character (i.e. type (a) surfactants as herein defined).

Typically, such additional stabilisers include mixtures of ascorbic acid, ascorbic palmitate and propyl gallate (under the tradenames Tenox® PG and Tenox® S-1); mixtures of butylated hydroxytoluene, butylated hydroxyanisole, propyl gallate and citric acid (under the tradename Tenox® 6); tertiary butylhydroquinone (under the tradename Tenox® TBHQ); natural tocopherols (under the tradenames Tenox® GT-1 and GT-2); long chain esters of gallic acid (under the tradenames Irganox® 1010, Irganox® 1035, Irganox® B 117 and Irganox® 1425) and mixtures thereof. Tenox products are supplied by Eastman Chemical Products Inc. Irganox products are supplied by Eastman Chemical Products Inc. The above stabilisers can also be mixed with chelating agents such as citric acid; 1-hydroxyethylidene-1,1-diphosphonic acid (Dequest® 2010, ex Monsanto); 4,5-dihydroxy-m-benzene-sulphonic acid/sodium salt (under the tradename Tiron®, ex Kodak) and diethylenetriaminepentaacetic acid (under the tradename DTPA, ex Aldrich).

Co-Active Softening Surfactants

Co-active softening surfactants for the cationic surfactant may also be incorporated in an amount from 0.01 to 20% by weight, more preferably 0.05 to 10%, based on the total weight of the composition. Preferred co-active softening surfactants are fatty acids, fatty amines and fatty N-oxides.

Perfumes

The compositions of the invention may also comprise one or more perfumes.

When present, the perfume is used in a concentration of preferably from 0.01-15% by weight, more preferably from 0.05-10% by weight, most preferably from 0.1-5% by weight, e.g. 0.15 to 4.5% by weight based on the total weight of the composition.

Other Optional Ingredients

The compositions may also contain one or more optional ingredients conventionally included in fabric conditioning compositions such as pH buffering agents, perfume carriers, colourants, hydrotropes, antifoaming agents, antiredeposition agents, polyelectrolytes, enzymes, optical brightening agents, anti-shrinking agents, anti-wrinkle agents, anti-spotting agents, germicides, fungicides, anti-corrosion agents, drape imparting agents, anti-static agents, ironing aids and dyes.

Product Form

In its undiluted state at ambient temperature the product is in a clear or translucent liquid.

The composition may be an aqueous solution, a solvent based isotropic liquid or a microemulsion. Microemulsions are preferred.

Particularly preferred are micro-emulsions which are stable at between about 10° C. and about 50° C.

The compositions are generally provided in a highly concentrated form but have a viscosity that is acceptable to the consumer, i.e. pourable.

In the context of the present invention, the term “pourable” means that the compositions have a viscosity of 1 Pa.S (1000 cps) or less, preferably 0.7 Pa.S (700 cps) or less, more preferably 0.5 Pa.S (500 cps) or less, most preferably 0.25 Pa.S (250 cps) or less, e.g. 0.15 Pa.S (150 cps) or less at a shear rate of 106 s⁻¹ at 25° C., measured using a Haake rotoviscometer.

The compositions are stable, by which it is meant that immediately upon formation of the composition, there are no visible clumped particles present.

The composition is preferably used in the rinse cycle of a home textile laundering operation, where, it may be added directly in an undiluted state to the washing machine, e.g. through a dispenser drawer. Alternatively, it can be diluted prior to use. The compositions may also be used in a domestic hand-washing laundry operation.

Composition pH

When the composition is dispersed in water, the solution preferably has a pH of from 1.5 to 5.

### EXAMPLES

The invention will now be illustrated by the following non-limiting examples. Further modification within the scope of the present invention will be apparent to the person skilled in the art.

In the following examples, all amounts are percentage by weight unless other wise indicated.

The formulations in the following table were prepared by heating the cationic softener, ester oil, nonionic surfactant and water together to a temperature of 70° C. until clear, then allowing the mixture to cool whilst stirring. The perfume and fluorescer were then added with stirring.

TABLE 1

| | Product 1 | Product 2 | Product 3 | Product 4 |
|---|---|---|---|---|
| Tetranyl AOT-1 | 36.4 | 36.4 | — | — |
| Tetranyl ART-V | — | — | 34.25 | 34.25 |
| Estol 1545 | 35.8 | 35.7 | 37.95 | 37.95 |
| Coco 3EO | 4.8 | 4.8 | 4.8 | 4.8 |
| Water | 20 | 20 | 20 | 20 |
| Perfume | 3 | 3 | 3 | 3 |
| Blankophor DCB | 0 | 0.1 | 0 | 0.1 |

Product 1 is a clear viscous products with a yellowish tinge.

Product 2 is a clear viscous product that is nearly colourless, and exhibits a bright violet fluorescent effect when held up to an ultra-violet light source.

Products 3 and 4 are white opaque viscous products, that are too thick to pour.

The following formulations were prepared by heating the cationic softener, fatty alcohol and nonionic surfactant together until molten, pouring the mixture slowly into hot water (80° C.) with stirring, allowing the mixture to cool to ambient and then stirring in the perfume and fluorescer.

TABLE 2

| | Product 5 | Product 6 |
|---|---|---|
| Tetranyl ART-V | 13.41 | 13.41 |
| Tallow alcohol | 1.6 | 1.6 |
| Coco 20EO | 0.3 | 0.3 |
| Water | 83.69 | 83.59 |
| Perfume | 1 | 1 |
| Blankophor DCB | 0 | 0.1 |

Product 5 is opaque

Product 6 has the same appearance as product 3, but contains visible yellow flocs of the fluorescer.

These results demonstrate that stable, pourable, clear or translucent compositions are achieved when a specific fluorescer and an unsaturated quaternary ammonium cationic softening material is present.

Materials

Tetranyl AOT-1: di-oleyl ester of triethanol ammonium methyl sulphate, having IV of about 85. Material contains approx. 20% DPG solvent. (ex Kao).

Tetranyl AHT-V: di-hydrogenated tallow ester of triethanol ammonium methyl sulphate, having IV of about 0. Material contains approx. 15% IPA solvent. (ex Kao)

Estol 1545: octyl stearate (ex Uniqema)

Coco 3EO: C₁₂ alkyl ethoxylated with 3 moles ethylene oxide

Coco 20EO: C₁₂ alkyl ethoxylated with 20 moles ethylene oxide

Blankophor DCB: fluorescent whitener (ex Bayer)

1. A stable, pourable clear or translucent fabric conditioning composition comprising:
(i) one or more cationic fabric softening materials having an iodine value of from 5 to 140;
(ii) one or more oils and/or low molecular weight solvents;
(iii) one or more hydrophobic fluorescers,
wherein the weight ratio of cationic softening material to oil, when present is in the range 5:1 to 10:1 and the weight ratio of cationic softening material is low molecular weight solvent when present is in the range 8:1 to 1:3.

2. A composition according to claim 1 wherein the iodine value of the cationic fabric softening material is from 15 to 100.

3. A composition according to claim 1 wherein the iodine value of the cationic fabric softening material is from 35 to 95.

4. A composition according to claim 1 wherein the cationic fabric softening material is represented by the formula: 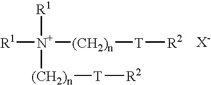
wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; 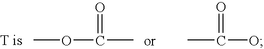
X⁻ is any anion compatible with the cationic surfactant, and n is 0 or an integer from 1-5.

5. A composition according to claim 4 wherein R¹ is a hydroxyalkyl group.

6. A composition according to claim 1 comprising 2,2,4-trimethyl-1,3-pentanediol.

7. A composition according to claim 6 comprising hexylene glycol.

8. A composition according to claim 1 which comprises a solvent-based isotropic liquid.

9. A method of conditioning fabrics comprising contacting the fabric conditioning composition according to claim 1 with fabrics.

10. (canceled)

11. A method of reducing yellowing of fabrics comprising contacting the fabric conditioning composition according to claim 1 with fabrics; wherein said composition comprises a fluorescer solubilized in the organic phase of said composition.
